(19) United States
(12) Patent Application Publication
(10) Pub. No.: US 2025/0362421 A1
(43) Pub. Date: Nov. 27, 2025

(54) LATENT DOMAIN SEISMIC FAULT DETECTION

(71) Applicant: Saudi Arabian Oil Company, Dhahran (SA)

(72) Inventors: Eyad Fuad Aljishi, Dhahran (SA); Bingbing Sun, Dhahran (SA)

(73) Assignee: Saudi Arabian Oil Company, Dhahran (SA)

(21) Appl. No.: 18/673,637

(22) Filed: May 24, 2024

(51) Int. Cl. G01V 1/30

(52) U.S. Cl. CPC G01V 1/301; G01V 2210/642

(57) ABSTRACT

Fault detection in seismic data using a latent representation of seismic data. Sample data may be created from seismic data and used to train an autoencoder. The autoencoder is used to generate a latent representation of seismic data. A fault attribute is computed by selecting two sets of traces in proximity to each other in the seismic data, generating their corresponding latent representations using the trained autoencoder, and computing a fault attribute between the two latent representations. The fault attribute is used to identify a fault in the seismic data.

### BACKGROUND

### Field of the Disclosure

The present disclosure generally relates to geophysical exploration using seismic surveying. More specifically, embodiments of the disclosure relate to the mapping of faults and other discontinuities in seismic images.

### Description of the Related Art

In geophysical exploration, such as the exploration for hydrocarbons, seismic surveys are performed to produce images of the various rock formations in the earth (“subsurface”) or underwater (“subsea”). The seismic surveys obtain seismic data indicating the response of the rock formations to the travel of elastic wave seismic energy. The resulting seismic data is processed and analyzed to yield information relating to produce seismic images of the formations and their locations in an area of interest beneath the earth's surface. In particular, seismic data interpretation may be useful in locating potential hydrocarbon resources in oil and gas exploration, as well as in determining secure and safe storage of carbon dioxide (CO₂) for Carbon Capture and Storage (CCS).

### SUMMARY

Seismic data interpretation may include the mapping of faults and discontinues in a formation. Conventional fault picking and mapping methods require involve labor-intensive manual two-dimensional (2D) faults picking, which is directly impacted by signal-to-noise (S/N) ratio. Other techniques for mapping faults use structural seismic attributes such as variance, edge detection, and semblance to extract fault-like features (for example, faults and channels/discontinuities) and may reduce manual effort. However, this approach is costly and time-consuming as it requires domain expertise and advanced software to extract the proper attributes. Moreover, the quality of the seismic attributes are sensitive to the signal-to-noise (S/N) ratio and defects in the data.

Machine learning based fault detection methods have potential in enhancing accuracy and efficiency. A typical machine learning based fault detection uses supervised learning techniques where labels (fault attributes) are required for given seismic images samples. However, the collection and labeling of a large amount of accurate training data is time-consuming and costly, often rendering it impractical.

In one embodiment, a method is provided for detecting a fault in seismic data generated from a seismic receiver station configured to sense seismic signals originating from a seismic source station. The method includes obtaining seismic data generated from the seismic receiver station, the seismic data including post-stack seismic data, selecting sample seismic data from the seismic data, and training an autoencoder using the sample seismic data. The method also includes selecting a first set of traces from the seismic data and a second set of traces from the seismic data, such that the first set of traces and the second set of traces are within a distance threshold, generating a first latent representation of the first set of traces using the autoencoder, and generating a second latent representation of the second set of traces using the autoencoder. The method further includes determining a fault attribute from the first latent representation and the second latent representation and identifying a fault in the seismic data based on the fault attribute.

In some embodiments, selecting sample seismic data from the post-stack seismic data includes defining a window length in the crossline dimension, a window length in the inline dimension, a window length in the time dimension, or any combination thereof. In some embodiments, determining a fault attribute from the first latent representation and the second latent representation includes computing an L₂ norm between the first latent representation and the second latent representation. In some embodiments, determining a fault attribute from the first latent representation and the second latent representation includes computing a cosine similarity between the first latent representation and the second latent representation. In some embodiments, determining a fault attribute from the first latent representation and the second latent representation includes computing a singular value decomposition (SVD) between the first latent representation and the second latent representation. In some embodiments, identifying a fault in the seismic data based on the fault attribute includes determining that the fault attribute is a maximum value as compared to a second fault attribute. In some embodiments, the method includes generating a seismic image from the attenuated seismic data.

In another embodiment, a non-transitory computer-readable storage medium having executable code stored thereon for detecting a fault in seismic data generated from a seismic receiver station configured to sense seismic signals originating from a seismic source station is provided. The executable code includes a set of instructions that causes a processor to perform operations that include obtaining seismic data generated from the seismic receiver station, the seismic data including post-stack seismic data, selecting sample seismic data from the seismic data, and training an autoencoder using the sample seismic data. The operations also include selecting a first set of traces from the seismic data and a second set of traces from the seismic data, such that the first set of traces and the second set of traces are within a distance threshold, generating a first latent representation of the first set of traces using the autoencoder, and generating a second latent representation of the second set of traces using the autoencoder. The operations further include determining a fault attribute from the first latent representation and the second latent representation and identifying a fault in the seismic data based on the fault attribute.

In some embodiments, selecting sample seismic data from the post-stack seismic data includes defining a window length in the crossline dimension, a window length in the inline dimension, a window length in the time dimension, or any combination thereof. In some embodiments, determining a fault attribute from the first latent representation and the second latent representation includes computing an L₂ norm between the first latent representation and the second latent representation. In some embodiments, determining a fault attribute from the first latent representation and the second latent representation includes computing a cosine similarity between the first latent representation and the second latent representation. In some embodiments, determining a fault attribute from the first latent representation and the second latent representation includes computing a singular value decomposition (SVD) between the first latent representation and the second latent representation. In some embodiments, identifying a fault in the seismic data based on the fault attribute includes determining that the fault attribute is a maximum value as compared to a second fault attribute. In some embodiments, the operations include generating a seismic image from the attenuated seismic data.

In another embodiment a system is provided that includes a seismic source station, a seismic receiver station configured to sense seismic signals originating from a seismic source station, a seismic data processor, and a non-transitory computer-readable storage memory accessible by the seismic data processor and having executable code stored thereon for detecting a fault in seismic data generated from the seismic receiver station. The executable code includes a set of instructions that causes a processor to perform operations that include obtaining seismic data generated from the seismic receiver station, the seismic data including post-stack seismic data, selecting sample seismic data from the seismic data, and training an autoencoder using the sample seismic data. The operations also include selecting a first set of traces from the seismic data and a second set of traces from the seismic data, such that the first set of traces and the second set of traces are within a distance threshold, generating a first latent representation of the first set of traces using the autoencoder, and generating a second latent representation of the second set of traces using the autoencoder. The operations further include determining a fault attribute from the first latent representation and the second latent representation and identifying a fault in the seismic data based on the fault attribute.

In some embodiments, selecting sample seismic data from the post-stack seismic data includes defining a window length in the crossline dimension, a window length in the inline dimension, a window length in the time dimension, or any combination thereof. In some embodiments, determining a fault attribute from the first latent representation and the second latent representation includes computing an L₂ norm between the first latent representation and the second latent representation. In some embodiments, determining a fault attribute from the first latent representation and the second latent representation includes computing a cosine similarity between the first latent representation and the second latent representation. In some embodiments, determining a fault attribute from the first latent representation and the second latent representation includes computing a singular value decomposition (SVD) between the first latent representation and the second latent representation. In some embodiments, identifying a fault in the seismic data based on the fault attribute includes determining that the fault attribute is a maximum value as compared to a second fault attribute. In some embodiments, the operations include generating a seismic image from the attenuated seismic data.

### BRIEF DESCRIPTION OF THE DRAWINGS

FIG. 1 is a flowchart of a process for detecting faults for detecting faults in seismic data using a latent domain in accordance with an embodiment of the disclosure;

FIG. 2 depicts an inline section of post-stack seismic data that may be used for training an autoencoder in accordance with an embodiment of the disclosure;

FIG. 3 is a schematic diagram of an autoencoder that may be used in accordance with an embodiment of the disclosure;

FIG. 4 depicts an inline section of a computed fault attribute volume in accordance with an embodiment of the disclosure;

FIG. 5 is a block diagram of a system for producing seismic data in accordance with an embodiment of the disclosure; and

FIG. 6 a block diagram of a seismic data processing system in accordance with an embodiment of the disclosure.

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

Embodiments of the disclosure are directed to a latent domain unsupervised fault detection in seismic data. Embodiments of the disclosure include a pre-trained autoencoder to automatically map discontinuities (for example, faults) in seismic data. A collection of traces from post-stack seismic volume is provided as the input to the autoencoder. The encoder of the autoencoder generates a compact representation (a latent domain) of the input with lower dimensionality. By using the decoder to reconstruct the traces, the autoencoder effectively extracts disentangled features which can map faults or other discontinuities in a self-supervised manner.

Advantageously, embodiments of the disclosure reduce the need for labor intensive manual fault picking, eliminate human bias, and reduce the time and resources required for fault identification in seismic data. Additionally, embodiments of the disclosure are robust to signal-to-noise (S/N) ratio and does not reply on predefined labels or expert knowledge, thus enabling the application to different seismic datasets.

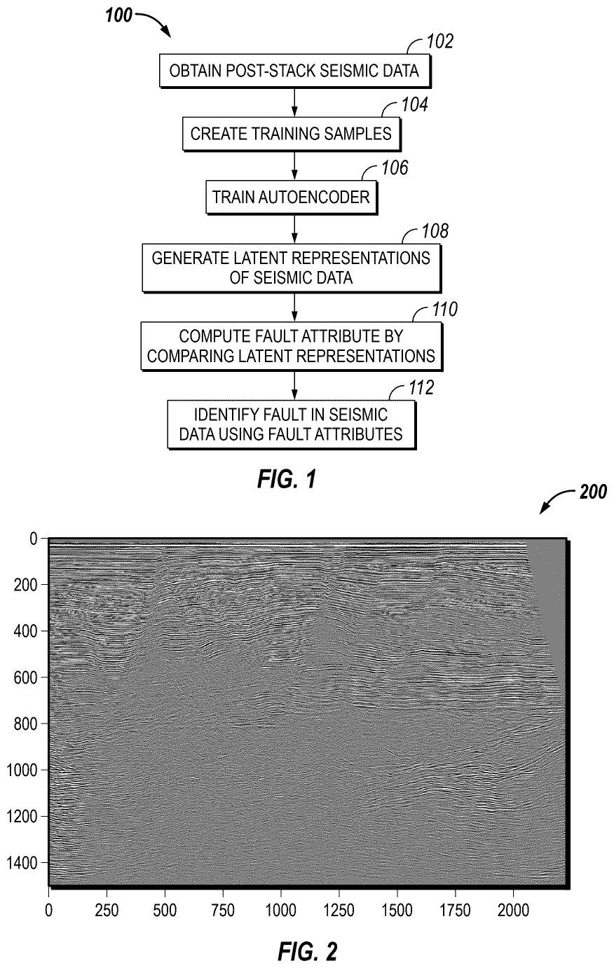

FIG. 1 depicts a process 100 for detecting faults in seismic data using a latent domain in accordance with an embodiment of the disclosure. The process 100 first includes obtaining post-stack seismic data (block 102), that is, data in which seismic traces have been added together (“stacked”) from different seismic records. The post-stack seismic data typically includes datasets formatted as cubes and presented as 3-dimensional arrays noted as DATA [n_{y}, nₓ, n_{z}], such that n_{y}, nₓ and n_{z} represent crossline, inline, and time dimension respectively. By way of example, FIG. 2 depicts an inline section 200 of post-stack seismic data that may be used for training an autoencoder in accordance with an embodiment of the disclosure.

Next sample data for training an autoencoder may be created from the seismic data (block 104). The sample data may be created by first defining windows lengths windy, windx and windz for the n_{y}, nₓ and n_{z} dimensions to extract collections of traces from the seismic cube, as shown in Equation 1:

$${x}_{iy , ix , iz} = DATA [ iy : iy + wndy ] [ ix : ix + wndx ] [ ix : ix + wndz ] \qquad [ 1 ]$$

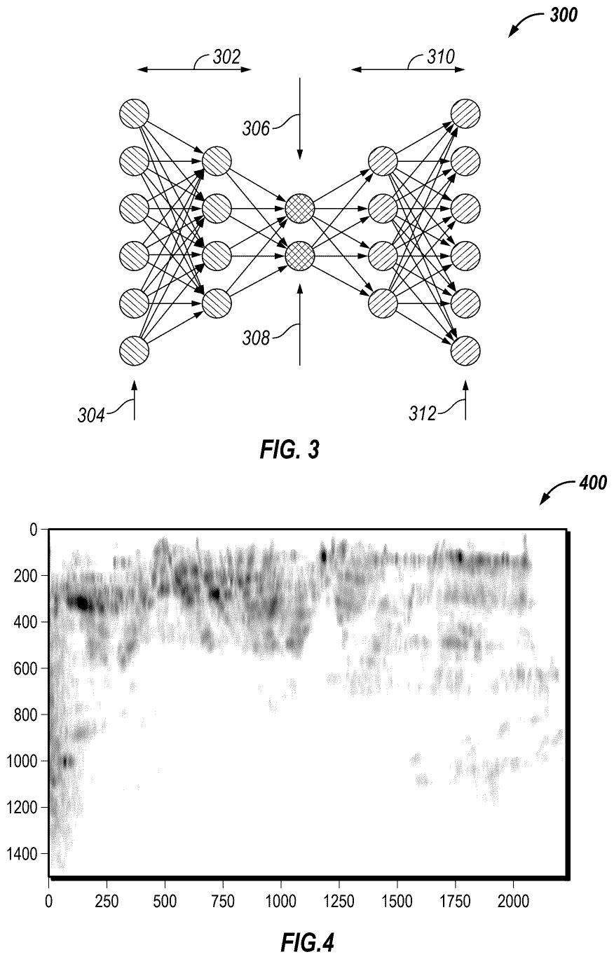

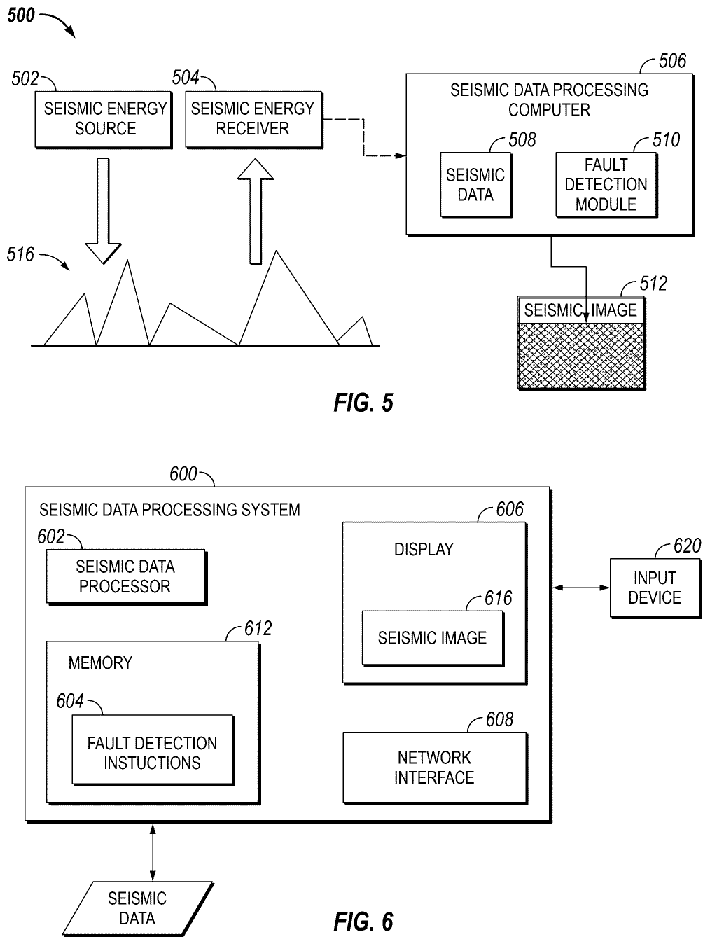

Next, different samples for training the autoencoder may be created by traversing through the indices iy, ix, and iy. For a sample x, the loss for training the autoencoder may defined as the reconstruction errors, according to the following:

$$L = {‖ {f}_{d e c} ( {f}_{e n c} ( x ; θ ) ; ϕ ) - x ‖}^{2} \qquad [ 2 ]$$

where θ is the neural parameter for the encoder and ϕ is the neural parameter for the decoder. After creating samples, the autoencoder may be trained on the sample data without labels (that is unsupervised) (block 106). As shown in FIG. 3, the autoencoder includes an encoder 302 for encoding input data 304, a latent space 306 defined by encoded data 308, and a decoder 310 for generating reconstructed data 312. The autoencoder is trained to learn a compact representation of the input data by encoding into a lower-dimensional space (the latent domain). The autoencoder may then reconstruct the data to its original dimensions by decoding. FIG. 3 is a schematic diagram of an autoencoder 300 that may be used in accordance with an embodiment of the disclosure.

The encoder of the autoencoder encodes the input data X and produces a compressed representation of that input. The lower dimensional representation produced in that step is called the latent domain (also referred to as “latent space”) and is denoted as z:

$$z = {f}_{e n c} ( X ) \qquad [ 3 ]$$

The latent space z is a compressed representation of the input X with much smaller dimensionality, enabling the autoencoder to capture the most significant and informative features of the input.

The decoder of the autoencoder uses the encoded representation stored in the latent domain to reconstruct the original input data, denoted as X′:

$${X}^{′} = {f}_{d e c} ( z ) \qquad [ 4 ]$$

The autoencoder may be trained by computing the derivatives of the loss with respect to the neural network parameters (θ, ϕ) and using stochastic gradient descent, as shown in Equations 5 and 6:

$$θ ← θ + {γ}_{θ} \frac{\partial L}{\partial θ} \qquad [ 5 ]$$

$$ϕ ← ϕ + {γ}_{θ} \frac{\partial L}{\partial ϕ} \qquad [ 6 ]$$

The neural network parameters may be updated until predefined iterations or accuracy threshold are reached.

In other embodiments, the latent representation may be generated using other neural network techniques. For example, in some embodiments a transformer may be used to generate the latent representation. In such embodiments, the input may be defined in the same manner as Equation 1 supra, and the transformer may be trained using a standard pretraining framework for large language models to predict the masked portion of the sample data. The resulting transformer would learn a meaningful latent representation for use in subsequent fault extraction.

The latent representation may be used to detect faults in the seismic data by computing a fault attribute. The faults may be detected by comparing the latent features of nearby traces. First, the trained autoencoder may generate latent representations of selected seismic data (block 108). To compute the fault attribute at a pixel indexed by (iy,ix,iz), two collections of traces close to each other in the original seismic cubes may be selected, as follows:

$${x}_{1} = DATA ( iy - wndy : iy ; ix - wndx : ix ; iz - wndz : iz ) \qquad [ 7 ]$$

$${x}_{2} = DATA ( iy : iy + w ndy ; ix : ix + wndx ; iz - wndz : iz ) \qquad [ 8 ]$$

The corresponding latent representations z1 and z2 for collections x1 and x2 may be obtained using the trained autoencoder, according to the following:

$${z}_{1} = {f}_{e n c} ( {x}_{1} ; θ ) \qquad [ 9 ]$$

$${z}_{2} = {f}_{e n c} ( {x}_{2} ; θ ) \qquad [ 10 ]$$

Using the two latent representations, a fault attribute may be computed (block 110). In some embodiments, the resulting fault attribute may be defined as the difference between the two latent representations z1 and z2, which may be determined through pixel-wise subtraction (that is, an L₂ norm determination) as follows:

$$FALUT ( iy , ix , iz ) = {‖ {z}_{1} - {z}_{2} ‖}^{2} \qquad [ 11 ]$$

Using Equation 11, the fault attribute is computed at position (iy, ix, iz). By way of example, FIG. 4 depicts an inline section 400 of a computed fault attribute volume in accordance with an embodiment of the disclosure. The fault attribute may be used to identify a fault in the seismic data (block 112). For example, the fault attribute may be compared to a threshold or another fault attribute to determine of the value of the fault attribute indicates a fault (for example, is greater than the threshold).

In other embodiments, the difference between two latent representations may be determined using other techniques. In some embodiments, another distance metric other than L₂ norm may be used. In some embodiments, the semblance of nearby latent representations may be determined, such as by using cosine similarity of other similarity measure. In some embodiments, matrix analysis techniques such as singular value decomposition (SVD) or other dimensionality reduction may be used to determine the difference between latent representations. In yet other embodiments, an unsupervised clustering technique (for example, k-means) may be used to distinguish between fault and no-fault latent representations by clustering latent representations into clusters based on fault features.

In some embodiments, the fault may be computed in other directions. For example, a fault may be computed along the inline direction (x-axis) by sampling data from nearby traces in that direction, as shown in Equations 12 and 13:

$${x}_{1} = DATA ( iy - wndy : iy ; ix - wndx : ix ; iz - wndz : iz ) \qquad [ 12 ]$$

$${x}_{2} = DATA ( iy - wndy : iy ; ix : ix + wndx ; iz - wndz : iz ) \qquad [ 13 ]$$

In another example, a fault may be computed along the crossline direction (y-axis) by sampling data according to the following:

$${x}_{1} = DATA ( iy - wndy : iy ; ix - wndx : ix ; iz - wndz : iz ) \qquad [ 14 ]$$

$${x}_{2} = DATA ( iy + wndy : iy ; ix : ix + wndx ; iz - wndz : iz ) \qquad [ 15 ]$$

In such embodiments, samples may be selected and the fault attribute computed along various directions to further provide more robust fault detection. In such embodiments, fault attributes with maximum values may be identified and other fault attributes below the maximum values may be discarded.

FIG. 8 depicts a system 500 for fault detection using latent representation in accordance with an embodiment of the disclosure. The system 500 can include, for example, a seismic source 502 (also referred to as a “seismic station”), a seismic receiver 506 (also referred to as a “receiver station”), a seismic data processing computer 506 that stores and processes seismic data 508, such as a shot gather responsive to seismic energy signals received by the seismic receiver, and a fault detection module 810 that detects faults in seismic data produced by the seismic receiver 506. Additionally, the seismic data processing computer 506 may produce a seismic image 512 from seismic data as is known in the art. According to various embodiments of the present disclosure, the seismic source 502 can include any seismic or acoustic energy whether from an explosive, implosive, swept-frequency, or random sources. The seismic source, for example, can generate a seismic energy signal that propagates into the earth 516.

Generally, the seismic source 502 can emit seismic waves into the earth 516 to evaluate subsurface conditions and to detect possible concentrations of oil, gas, and other subsurface minerals. Seismic waves may travel through an elastic body (such as the earth 516). The propagation velocity of seismic waves may depend on the particular elastic medium through which the waves travel, particularly the density and elasticity of the medium as is known and understood by those skilled in the art. The refraction or reflection of seismic waves onto a seismic receiver 504 can be used to research and investigate subsurface structures of the earth 516. Embodiments of the system 500 may include a plurality of seismic sources arranged in an array.

Accordingly, the seismic receiver 504 can be positioned to receive and record seismic energy data or seismic field records in any form including, but not limited to, a geophysical time series recording of the acoustic reflection and refraction of waveforms that travel from the seismic source 502 to the seismic receiver 504. Variations in the travel times of reflection and refraction events in one or more field records in seismic data processing can produce seismic data 508 that demonstrates subsurface structures and enables the identification of discontinuities in accordance with the embodiment described in the disclosure. Seismic images produced from the seismic image data may be used to aid in the search for, and exploitation of, subsurface mineral deposits in the geological structure.

Generally speaking, seismic receivers 504 can record sound wave echoes (otherwise known as seismic energy signal reflections) that come back up through the ground from a seismic source 502 to a recording surface. Such seismic receivers 504 can record the intensity of such sound waves and the time it took for the sound wave to travel from the seismic source 502 back to the seismic receiver 504 at the recording surface. According to embodiments of the present disclosure, for example, during the seismic imaging process, the reflections of sound waves emitted by a seismic source 502, and recorded by a seismic energy recording 504, can be processed by a computer to detect faults in the present in the earth 516. The detected faults and resulting seismic image of the subsurface can be used to identify, for example, the placement of wells and potential well flow paths.

More specifically, the term seismic receiver 504 as is known and understood by those skilled in the art, can include geophones, hydrophones and other sensors designed to receive and record seismic energy. Accordingly, by placing a plurality of geophone seismic receivers 504 at a recording surface, a two-dimensional seismic image can be produced responsive to seismic data recorded by the geophone seismic receivers 504. Embodiments of the system 500 may include a plurality of seismic receivers having a designated spacing between each receiver 504.

According to an embodiment of the present disclosure, a seismic receiver 504 can be positioned to receive and record seismic energy data or seismic field records in any form including a geophysical time series recording of the acoustic reflection and refraction of waveforms that travel from the seismic source 502 to the seismic receiver 504. Variations in the travel times of reflection and refraction events in one or more field records in a plurality of seismic signals can, when processed by the seismic data processing computer 506, produce seismic data 508 that demonstrates subsurface structure. As described herein, prior to using a seismic data 508 to aid in the search for, and exploitation of, mineral deposits, the seismic data 508 may be processed to identify faults or other discontinuities. The interpretation of the seismic image 512 generated from such data may be used to determine the location of wells drilling into the earth 516. Thus, one or more drills may be drilled into the earth 516 in response to the generation and interpretation of the seismic image 512.

FIG. 6 depicts components of a seismic data processing computer 600 in accordance with an embodiment of the disclosure. In some embodiments, seismic data processing computer 600 may be in communication with other components of a system for obtaining and producing seismic data. Such other components may include, for example, seismic shot stations (sources) and seismic receiving stations (receivers). As shown in FIG. 6, the seismic data processing computer 600 may include a seismic data processor 602, a memory 604, a display 606, and a network interface 608. It should be appreciated that the seismic data processing computer 600 may include other components that are omitted for clarity. In some embodiments, seismic data processing computer 600 may include or be a part of a computer cluster, cloud-computing system, a data center, a server rack or other server enclosure, a server, a virtual server, a desktop computer, a laptop computer, a tablet computer, or the like.

The seismic data processor 602 (as used the disclosure, the term “processor” encompasses microprocessors) may include one or more processors having the capability to receive and process seismic data, such as data received from seismic receiving stations. In some embodiments, the seismic data processor 602 may include an application-specific integrated circuit (AISC). In some embodiments, the seismic data processor 602 may include a reduced instruction set (RISC) processor. Additionally, the seismic data processor 602 may include a single-core processors and multicore processors and may include graphics processors. Multiple processors may be employed to provide for parallel or sequential execution of one or more of the techniques described in the disclosure. The seismic data processor 602 may receive instructions and data from a memory (for example, memory 604).

The memory 604 (which may include one or more tangible non-transitory computer readable storage mediums) may include volatile memory, such as random access memory (RAM), and non-volatile memory, such as ROM, flash memory, a hard drive, any other suitable optical, magnetic, or solid-state storage medium, or a combination thereof. The memory 604 may be accessible by the seismic data processor 602. The memory 604 may store executable computer code. The executable computer code may include computer program instructions for implementing one or more techniques described in the disclosure. For example, the executable computer code may include fault detection instructions 612 that define a fault detection module to implement embodiments of the present disclosure. In some embodiments, the fault detection instructions 612 may implement one or more elements of process 100 described above and illustrated in FIG. 1. In some embodiments, the fault detection instructions 612 may receive, as input, seismic data 610 and may produce, as output, an identification of faults in the seismic data. In some embodiments, a seismic image 616 may be produced, stored in the memory 604 and, as shown in FIG. 6, displayed on the display 606.

The display 606 may include a cathode ray tube (CRT) display, liquid crystal display (LCD), an organic light emitting diode (OLED) display, or other suitable display. The display 606 may display a user interface (for example, a graphical user interface) that may display information received from the plant information processing computer 606. In accordance with some embodiments, the display 606 may be a touch screen and may include or be provided with touch sensitive elements through which a user may interact with the user interface.

The network interface 608 may provide for communication between the seismic data processing computer 600 and other devices. The network interface 608 may include a wired network interface card (NIC), a wireless (e.g., radio frequency) network interface card, or combination thereof. The network interface 608 may include circuitry for receiving and sending signals to and from communications networks, such as an antenna system, an RF transceiver, an amplifier, a tuner, an oscillator, a digital signal processor, and so forth. The network interface 608 may communicate with networks, such as the Internet, an intranet, a wide area network (WAN), a local area network (LAN), a metropolitan area network (MAN) or other networks. Communication over networks may use suitable standards, protocols, and technologies, such as Ethernet Bluetooth, Wireless Fidelity (Wi-Fi) (e.g., IEEE 802.11 standards), and other standards, protocols, and technologies. In some embodiments, for example, the unprocessed seismic data 6010 may be received over a network via the network interface 608. In some embodiments, for example, the seismic image 616 may be provided to other devices over the network via the network interface 608.

In some embodiments, seismic data processing computer may be coupled to an input device 620 (for example, one or more input devices). The input devices 620 may include, for example, a keyboard, a mouse, a microphone, or other input devices. In some embodiments, the input device 620 may enable interaction with a user interface displayed on the display 606. For example, in some embodiments, the input devices 620 may enable the entry of inputs that control the acquisition of seismic data, the processing of seismic data, and so on.

The following examples are included to demonstrate embodiments of the disclosure. It should be appreciated by those of skill in the art that the techniques and compositions disclosed in the example which follows represents techniques and compositions discovered to function well in the practice of the disclosure, and thus can be considered to constitute modes for its practice. However, those of skill in the art should, in light of the present disclosure, appreciate that many changes can be made in the specific embodiments which are disclosed and still obtain a like or a similar result without departing from the spirit and scope of the disclosure.

Ranges may be expressed in the disclosure as from about one particular value, to about another particular value, or both. When such a range is expressed, it is to be understood that another embodiment is from the one particular value, to the other particular value, or both, along with all combinations within said range.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used in the disclosure are for organizational purposes only and are not meant to be used to limit the scope of the description.

What is claimed is:

1. A method for detecting a fault in seismic data generated from a seismic receiver station configured to sense seismic signals originating from a seismic source station, the method comprising:
obtaining seismic data generated from the seismic receiver station, the seismic data comprising post-stack seismic data;
selecting sample seismic data from the seismic data;
training an autoencoder using the sample seismic data;
selecting a first set of traces from the seismic data and a second set of traces from the seismic data, wherein the first set of traces and the second set of traces are within a distance threshold;
generating a first latent representation of the first set of traces using the autoencoder;
generating a second latent representation of the second set of traces using the autoencoder;
determining a fault attribute from the first latent representation and the second latent representation; and
identifying a fault in the seismic data based on the fault attribute.

2. The method of claim 1, wherein selecting sample seismic data from the post-stack seismic data comprises defining a window length in the crossline dimension, a window length in the inline dimension, a window length in the time dimension, or any combination thereof.

3. The method of claim 1, wherein determining a fault attribute from the first latent representation and the second latent representation comprises computing an L₂ norm between the first latent representation and the second latent representation.

4. The method of claim 1, wherein determining a fault attribute from the first latent representation and the second latent representation comprises computing a cosine similarity between the first latent representation and the second latent representation.

5. The method of claim 1, wherein determining a fault attribute from the first latent representation and the second latent representation comprises computing a singular value decomposition (SVD) between the first latent representation and the second latent representation.

6. The method of claim 1, wherein identifying a fault in the seismic data based on the fault attribute comprises determining that the fault attribute comprises a maximum value as compared to a second fault attribute.

7. The method of claim 1, comprising generating a seismic image from the attenuated seismic data.

8. A non-transitory computer-readable storage medium having executable code stored thereon for detecting a fault in seismic data generated from a seismic receiver station configured to sense seismic signals originating from a seismic source station, the executable code comprising a set of instructions that causes a processor to perform operations comprising:
obtaining seismic data generated from the seismic receiver station, the seismic data comprising post-stack seismic data;
selecting sample seismic data from the seismic data;
training an autoencoder using the sample seismic data;
selecting a first set of traces from the seismic data and a second set of traces from the seismic data, wherein the first set of traces and the second set of traces are within a distance threshold;
generating a first latent representation of the first set of traces using the autoencoder;
generating a second latent representation of the second set of traces using the autoencoder;
determining a fault attribute from the first latent representation and the second latent representation; and
identifying a fault in the seismic data based on the fault attribute.

9. The non-transitory computer-readable storage medium of claim 8, wherein selecting sample seismic data from the post-stack seismic data comprises defining a window length in the crossline dimension, a window length in the inline dimension, a window length in the time dimension, or any combination thereof.

10. The non-transitory computer-readable storage medium of claim 8, wherein determining a fault attribute from the first latent representation and the second latent representation comprises computing an L₂ norm between the first latent representation and the second latent representation.

11. The non-transitory computer-readable storage medium of claim 8, wherein determining a fault attribute from the first latent representation and the second latent representation comprises computing a cosine similarity between the first latent representation and the second latent representation.

12. The non-transitory computer-readable storage medium of claim 8, wherein determining a fault attribute from the first latent representation and the second latent representation comprises computing a singular value decomposition (SVD) between the first latent representation and the second latent representation.

13. The non-transitory computer-readable storage medium of claim 8, wherein identifying a fault in the seismic data based on the fault attribute comprises determining that the fault attribute comprises a maximum value as compared to a second fault attribute.

14. The non-transitory computer-readable storage medium of claim 8, the operations comprising generating a seismic image from the attenuated seismic data.

15. A system, comprising:
a seismic source station;
a seismic receiver station configured to sense seismic signals originating from a seismic source station;
a seismic data processor;
a non-transitory computer-readable storage memory accessible by the seismic data processor and having executable code stored thereon for detecting a fault in seismic data generated from the seismic receiver station, the executable code comprising a set of instructions that causes the seismic data processor to perform operations comprising:
obtaining seismic data generated from the seismic receiver station, the seismic data comprising post-stack seismic data;
selecting sample seismic data from the seismic data;
training an autoencoder using the sample seismic data;
selecting a first set of traces from the seismic data and a second set of traces from the seismic data, wherein the first set of traces and the second set of traces are within a distance threshold;
generating a first latent representation of the first set of traces using the autoencoder;
generating a second latent representation of the second set of traces using the autoencoder;
determining a fault attribute from the first latent representation and the second latent representation; and
identifying a fault in the seismic data based on the fault attribute.

16. The system of claim 15, wherein selecting sample seismic data from the post-stack seismic data comprises defining a window length in the crossline dimension, a window length in the inline dimension, a window length in the time dimension, or any combination thereof.

17. The system of claim 15, wherein determining a fault attribute from the first latent representation and the second latent representation comprises computing an L₂ norm non-transitory computer-readable storage medium of claim 8the first latent representation and the second latent representation.

18. The system of claim 15, wherein determining a fault attribute from the first latent representation and the second latent representation comprises computing a cosine similarity non-transitory computer-readable storage medium of claim 8the first latent representation and the second latent representation.

19. The system of claim 15, wherein determining a fault attribute from the first latent representation and the second latent representation comprises computing a singular value decomposition (SVD) non-transitory computer-readable storage medium of claim 8the first latent representation and the second latent representation.

20. The system of claim 15, wherein identifying a fault in the seismic data based on the fault attribute comprises determining that the fault attribute comprises a maximum value as compared to a second fault attribute.

21. The system of claim 15, the operations comprising generating a seismic image from the attenuated seismic data.
